(19) United States
(12) Patent Application Publication
(10) Pub. No.: US 2014/0058877 A1
(43) Pub. Date: Feb. 27, 2014

(54) Auctions with Socially-connected Private Advance Offerings

(71) Applicants: Kulvir Singh Bhogal, Austin, TX (US); Rick Allen Hamilton, II, Charlottesville, VA (US); James Robert Kozloski, Yorktown Heights, NY (US); Clifford Alan Pickover, Yorktown Heights, NY (US)

(72) Inventors: Kulvir Singh Bhogal, Austin, TX (US); Rick Allen Hamilton, II, Charlottesville, VA (US); James Robert Kozloski, Yorktown Heights, NY (US); Clifford Alan Pickover, Yorktown Heights, NY (US)

(73) Assignee: INTERNATIONAL BUSINESS MACHINES CORPORATION, Armonk, NY (US)

(21) Appl. No.: 14/067,283

(22) Filed: Oct. 30, 2013

Related U.S. Application Data
(63) Continuation of application No. 13/296,515, filed on Nov. 15, 2011.

(51) Int. Cl. G06Q 50/00; G06Q 30/08

(52) U.S. Cl. CPC G06Q 50/01; G06Q 30/08
USPC 705/26.3

(57) ABSTRACT

Auctions with socially-connected private advance offerings are provided by by a social auction integration server by receiving at least one parameter regarding an item to be offered in an online auction by an offeror user; using the parameter and an identifier of the offeror user, searching at least one social network server for identifies of friends and associates that have a recorded affinity for the item or for similar items; preparing a list of the friend users and associate users; configuring a restricted auction wherein only the friend users and associate users are allowed to review and bid on the offered item; and providing the friend users and associate users a digital means for accessing the restricted auction.

### CROSS-REFERENCE TO RELATED APPLICATIONS (CLAIMING BENEFIT UNDER 35 U.S.C. 120)

This is a continuation of U.S. application Ser. No. 13/296,515, our docket AUS920110368US1, filed on Nov. 15, 2011. by Kulvir S. Bhogal, et al.

### INCORPORATION BY REFERENCE

Related U.S. application Ser. No. 13/296,515, our docket AUS920110368US1, filed on Nov. 15, 2011. by Kulvir S. Bhogal, et al., is hereby incorporated by reference in its entirety including drawings.

### FEDERALLY SPONSORED RESEARCH AND DEVELOPMENT STATEMENT

None.

### MICROFICHE APPENDIX

Not applicable.

### FIELD OF THE INVENTION

The invention generally relates to tools and utilities for assisting users of an online or electronic auction system to offer items for sale to auction participants who are more likely to purchase the item due to known social relationships between the offerror and the participants.

### BACKGROUND OF INVENTION

FIG. 3 shows a generalization of the well-known arrangement (600) of components for an electronic or online auction. Generally, one or more computer networks (601) interconnect at least one offeror's console with typically a plurality of bidder's consoles, and one or more auction server computers (602). The offeror's console may be a variety of computer devices, such as a personal computer (desktop, laptop, notebook, etc.), a tablet computer, or a smart cellular telephone phone (e.g. Apple iPhone™, Google Android™ phone, Research in Motion Blackberry™, etc.). The bidder's console(s) may take the same various forms as the offeror's console. The auction server may also be of one of these forms of computer devices, and alternatively it may be a more powerful “server” class of machine, such as an enterprise server, blade server, etc., running a much more capable operating system, such as IBM's AIX™, or a variant of UNIX™. Additionally, the auction server may be a conglomeration of hardware and software assets dynamically tasked to achieve the logical results of an auction server, such as an on-demand computing environment, a “cloud” computing environment, and a grid computing environment. The interconnecting computer networks may include one or more suitable data and voice communications networks, such as the Internet, an intranet, a virtual private network, a wireless network, a local area network, a wide area network, a telephone network, a radio link, and an optical link.

To place an item “up for auction”, an offeror console (603) is used to create and upload certain digital assets regarding the offered item, as well as one or more offering parameters, to the auction server. The digital assets might include one or more digital photographs, one or more video clips, and one or more textual descriptions of the item. The offering parameters may include identification information regarding the offering party (e.g. name, address, email address, web site address, telephone number, ratings or rankings for previously auctioned items, etc.), as well as parameters regarding the price (and optionally quantity) of the item(s) being offered (e.g. minimum bid, “buy it now” price, auction opening time and date, and auction closing time and date).

The auction server receives and stores the digital assets for the item in a database (608), for later retrieval and transmission to the bidder consoles during the auction. The auction server receives and stores the offering parameters and implements those in a profile for the auction associated with the offeror's account.

After the auction opening time and date, and prior to the auction's closing time and date, the auction server then interacts with the bidder's consoles to provide the digital assets for the item being offered, as well as to provide any bid status information (e.g. minimum bid, maximum bid, current bid, time left to close, etc.) to a bidding party. The auction server receives from the bidder console(s) one or more bids containing bid parameters (e.g. bid or offer-to-buy value, optionally with quantity indicator). The auction server then processes each received bid according to one or more auction schema (e.g. straight auction, Dutch auction, reverse auction, etc.), and updates the bid status and auction status for the item being offered. For example, if a bid is below the minimum bid offering parameter, the bid may be rejected. If a bid is above the minimum bid offering parameter and bests the current bid level, the bid may be accepted and the current bid level updated to reflect the best bid. If the bid meets or exceeds the maximum bid, the auction may be closed and the item may be marked as sold. When the auction closing time and date arrives, the auction may be closed and the current bid declared the “winner”. And, if a bid is received after the auction closing time and date, the bid may be rejected.

Ultimately, the auction is concluded with or without the item being sold. If no bids above the minimum bid offering parameter are received, then the auction may close without a winner or purchaser. If the auction is concluded during active bidding upon the expiration of the auction “window”, then the best bid is selected, where “best” may be the highest monetary value bid, or may be a combination of monetary bid value and quantity bid (in the situation of multiple items being available). For example, an airline offering seats on a particular flight route may accept a lower “dollar per seat” bid value if the bidder is offering to purchase a superior quantity of seats.

Upon the conclusion of the auction, with or without a successful sale being consummated, the auction server may archive certain information, such as the digital assets for the offered item, the bid parameters (winning bid value and quantity), and auction results (identification of winning party(ies), etc.) into a historical sales database (609). This information is then used to facilitate billing of the bidding party, reimbursement of the offering party, and other administrative functions (auditing, accounting, marketing, etc.).

### SUMMARY OF THE INVENTION

Auctions with socially-connected private advance offerings are provided by a social auction integration server by receiving at least one parameter regarding an item to be offered in an online auction by an offeror user; using the parameter and an identifier of the offeror user, searching at least one social network server for identifies of friends and associates that have a recorded affinity for the item or for similar items; preparing a list of the friend users and associate users; configuring a restricted auction wherein only the friend users and associate users are allowed to review and bid on the offered item; and providing the friend users and associate users a digital means for accessing the restricted auction.

### BRIEF DESCRIPTION OF THE DRAWINGS

The description set forth herein is illustrated by the several drawings.

FIG. 1 illustrates the improved arrangement of components of an electronic or online auctioning system according to at least one embodiment of the present invention.

FIG. 2 depicts a logical process according to the present invention.

FIG. 3 illustrates a generalization of well-known components of an online or electronic auction system.

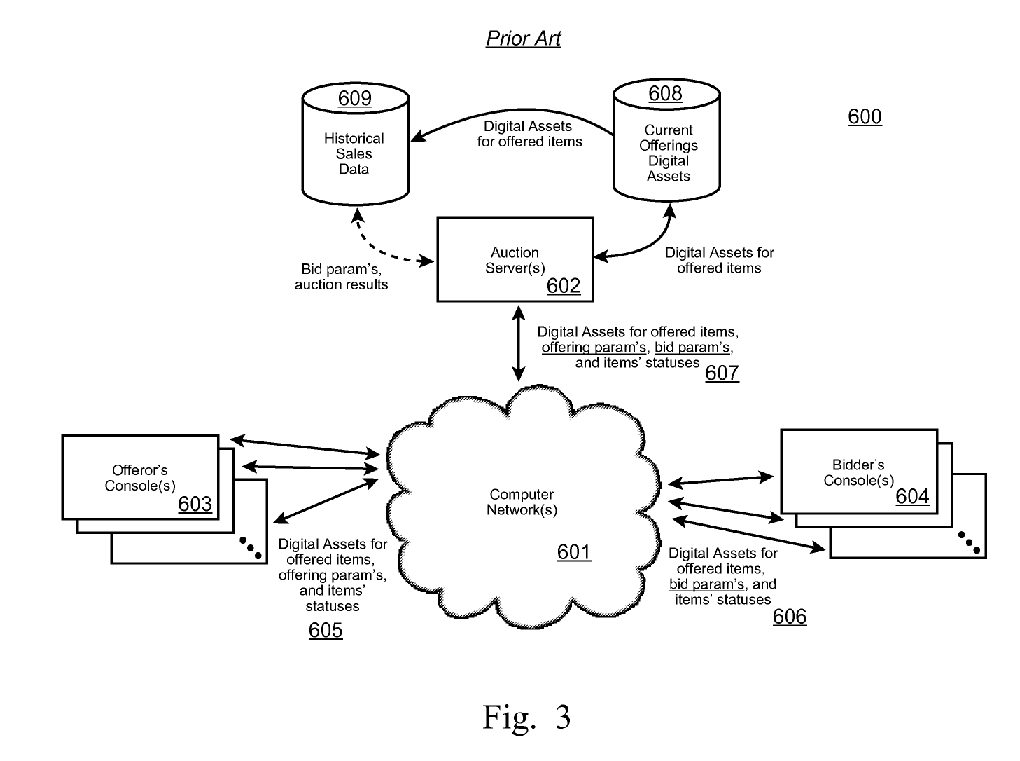

FIG. 4 sets forth a generalized architecture of computing platforms suitable for at least one embodiment of the related invention.

### DETAILED DESCRIPTION OF EMBODIMENT(S) OF THE INVENTION

The inventors of the present and related inventions have recognized problems and opportunities not yet recognized by those skilled in the relevant arts. The inventors have realized that when an offering party, whether they be an individual person or a corporate entity, wishes to offer an item for sale in an online or electronic action, they often immediately make it available in an auction which is widely available to bidders. However, often after an item is sold, the offeror will discover that a close friend, family member or business associate may have been interested in purchasing the item.

For example, a private (non-business entity) person decides to sell his or her performance bicycle via a globally-available auction. As bicycling is a world-wide sport, this exposes the item to a very wide range of potential buyers, which is good in some ways. It increases the chance of finding a buyer who will pay a top price for the item. However, to deliver the item, it may have to be packed and shipped to a distant destination, possibly even out of country. And, because the buyer and the seller are not previously known to each other, there is an element of risk of fraud by one or both of the parties involved.

Continuing with this example, soon after the seller sells his or her bicycle, he or she purchases a new bicycle and attends a bike race with a local bike club where he or she is a member. His or her friends, being familiar with the old (now sold and shipped) bike, notice the new bike and inquire as to where the old bike is. The seller then learns that someone he or she already knew through a social network, such as a club or an association, may have been interested in purchasing the bike. Since this person was already familiar with both the bike and the seller, a top price may have been obtained as well, and saving the cost and inconvenience of packing and shipping the bike. Further, the chance of fraud could have been minimized by conducting the transaction between trusted parties.

In the past, many such social clubs and organizations have offered “bulletin board” services online, or even “classified ads” in a periodic newsletter. This attempts to sell the item to a previously-known-to-be-interested set of friends and associates.

These listing services, however are separate and distinct from the online auction services and listing services known today, such as eBay™ and Craig's List™. So, for an offeror to take advantage of such a group, organization or club listing, he or she must list the item separately in each relevant bulletin board or newsletter, which may be time consuming to re-enter textual information and potentially videos and photographs. Further, if he or she lists an item simultaneously in multiple lists and newsletters, a timing conflict may arise between two or more interested parties as to who makes the best offer first and should obtain the item.

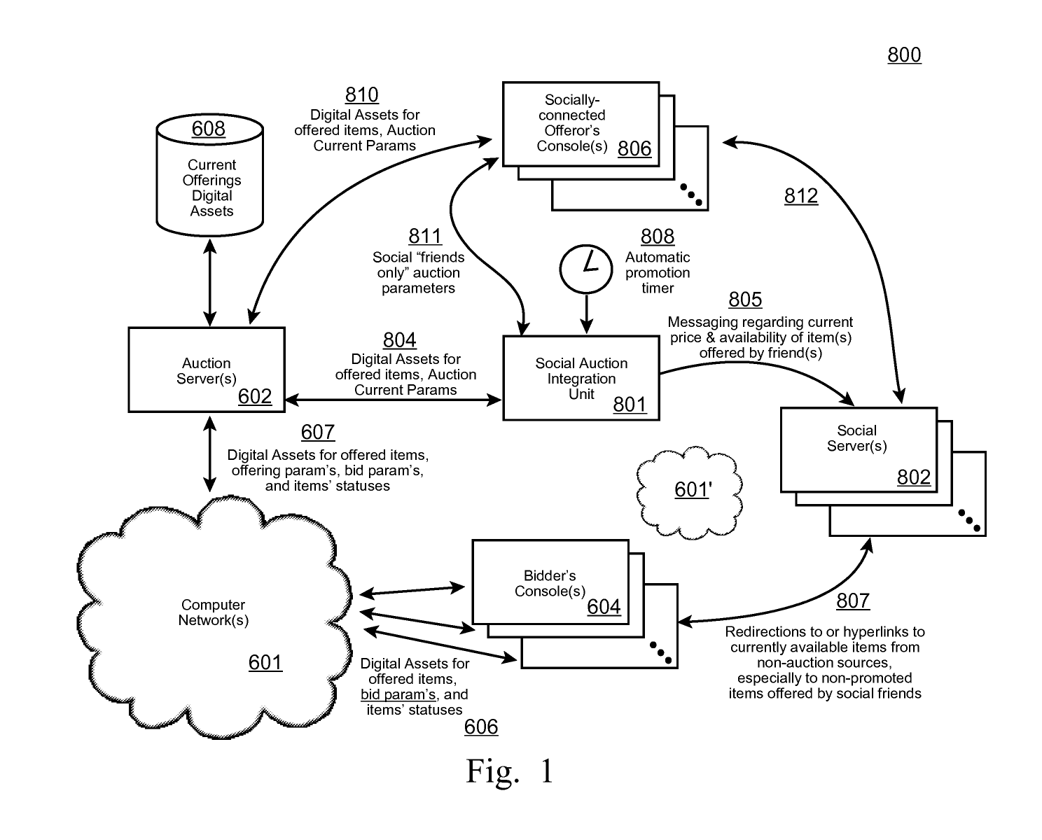

The inventors of the present invention recognize this problem, and see this as an opportunity. To address the problem, an improved arrangement of components according to the invention, such as the arrangement (800) shown in FIG. 1, may be adopted wherein a Social Auction Integration Unit (SAIU) (801) interfaces to and leverages the auctioning functionality of one or more auction servers (602), and one or more Social Servers (802). The Social Servers may be servers such as Google+™, Spoke™, FaceBook™, LinkedIn™, and the like. In practice, the functionality of the SAIU, which will be described in the following paragraphs in detail, may be integrated in part or whole into the auction servers, the social servers, or a combination of both, or the SAIU may be a separate and distinct server computer from the social and auction server systems.

The offeror console (806) is enhanced to interact (811) with the SAIU, and to directly or indirectly interact (812) with the Social Server(s) (802), and it leverages the existing interactions (810) with the Auction Servers (602) to create the listing(s) for items being offered into one or more auctions.

When a user of a socially-connected offeror console (806) wishes to offer an item for sale into an auction, the console (806) will offer the user the option to initially provide a “private” or “restricted” offering only to “friends” or “associates” known to the user via one or more social servers (802). If selected or enabled by the user, the SAIU (801) then obtains the user's friends lists from the social servers, and may optionally scan one or more associated “pages”, message repositories, photo albums, and membership lists to find potential social friends and associates who may be interested in the offered item.

For example, using the bicycle of the previous example, the SAIU may scan the social servers for the user's membership in bicycling clubs, and extract all the members from the membership list of the bicycling clubs to which the user belongs, or to which the user has established an affinity (e.g. “liked”). The SAIU may also scan the message repositories of the user in the Social Server(s) including emails, private messages, instant messages, “wall postings”, etc., to find messages including variations of the word(s) bike, bicycle and ride. All parties to those messages (senders, receivers, copied recipients, etc.) are added to the list of club members already collected. Further, the SAIU may scan photo albums, looking for “tagged” friends and associates in photos captioned as bike, bicycle and ride. In even more advanced embodiments, image analysis may be performed on photos and videos to detect images of bicycles, and to collect the friends and associates names from the facial tags in those items, as well.

Now, the SAIU has built a list of friends and associates, from a variety of sources (clubs, “liked” pages, messages, photos, etc.) who have some relationship to the user involving bicycles or bike riding. This is a group of potential buyers for the bicycle, which is proposed (811) to the user of the socially-connected offeror's console (806) as the membership list of the initial restricted auction offering.

Next, the user, via the offeror console (806), may select all or some of the proposed members of the initial restricted offering, and communicate this to the SAIU (801) with one or more private/restricted auction parameters (811). These parameters (811) may include the initial offering price, a “buy it now”, and an auction opening and closing time and date. Further, according to at least one embodiment of the invention, an automatic promotion timer (808) may be enabled, upon the expiration of which the SAIU automatically makes the item available for bidding on the Auction Servers (602) by all users of the auction (e.g. non-restricted, non-private offering).

Responsive to these parameters and commands, the SAIU may then notify (805) the selected friends and associates via their social pages on the Social Servers (802), such as by sending private messages through the social servers, posting on their pages, etc. Optionally, this communication may include some or all of the digital assets (810) for the offered item (e.g. pictures, text descriptions, price, etc.), and may include a key, code or link to access the restricted auction.

Following receipt of the notifications from the SAIU, one or more of the invited friends and associates may then operate their own bidder console (604) using the special hyperlink, key or code to enter the restricted or private auction on the Auction Server (602). During the duration of the private or restricted offering, these specially-invited friends and associates may then bid on the item, with which they are likely already familiar, and which is offered by someone with whom they are already known or trusted. Further, in many situations, it is likely that the item is actually locally held or stored to the bidders, so shipping and delivery costs and delays can be completely avoided.

In the optional embodiment which includes the automatic promotion of the offered items from a private or restricted auction to a generally open auction, the SAIU may, upon expiration (808) of the private auction window, update the auction conditions and parameters (804) to the Auction Server (602) such that no special code, key or hyperlink is needed in order to access the offered item and auction details. This opens the auction to bidding from the general public, or from a group of bidders which is broader than the group of friends and associates previously allowed to bid during the private or restricted auction.

Logical Processes.

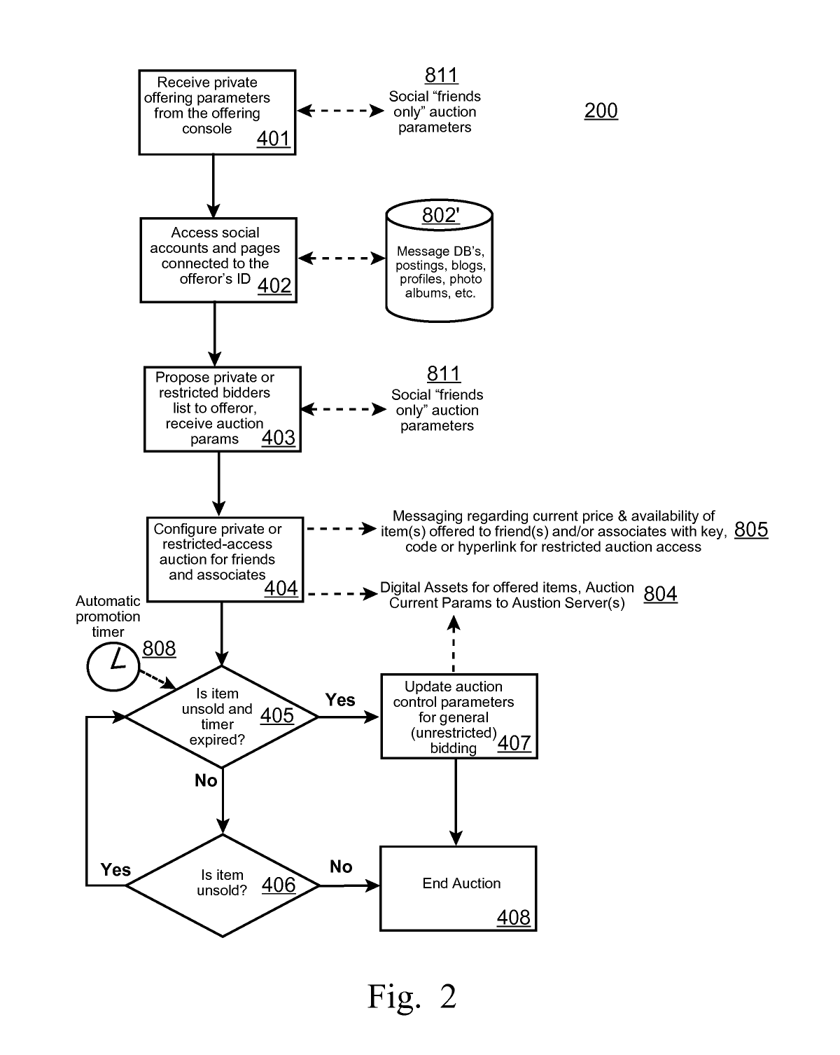

Turning to FIG. 2, a logical process (200) according to at least one embodiment of the present invention is shown in which the SAIU receives (401) initial parameters regarding the item to be sold from the offering console. The parameters, such as a text description of the item, to access (402) the social pages and accounts (802′) of the “friends” or “associates” connected to the offeror's identity (ID) in the social servers. Message databases, postings, blogs, profiles, and photo albums (802′) are optionally searched for socially-linked users who have discussed, posted about, or shown interest in keywords extracted from the initial parameters.

A list of “friends” and “associates” is compiled by the SAIU and proposed (403) to the offeror via the offering console. Subsequently, all or part of the compiled list is received from the offeror's console, including private auction control parameters (e.g. starting price, maximum price, auction open time, auction close time, enablement of automatic promotion to general bidding, etc.).

Next (404), the SAIU will configure the private or restricted-access auction for the item in the Auction servers, and will perform messaging and notification of the selected friends and associates via the Social Servers, such as by sending a private message to each invitee containing a hyperlink, code or key to access the private auction on the auction server.

If the automatic promotion timer is enabled and it expires before the item sells to a friend or associate (405), then the SAIU will update the auction control parameters at the Auction Servers to allow for unrestricted, general bidding (407) by a broader group of bidders than the list of friends and associates. Otherwise, while the item remains unsold and the private or restricted auction window remains open (406), the private auction will continue on the Auction Server until ended (408).

Suitable Computing Platform.

Regarding computers for executing the logical processes set forth herein, it will be readily recognized by those skilled in the art that a variety of computers are suitable and will become suitable as memory, processing, and communications capacities of computers and portable devices increases. In such embodiments, the operative invention includes the combination of the programmable computing platform and the programs together. In other embodiments, some or all of the logical processes may be committed to dedicated or specialized electronic circuitry, such as Application Specific Integrated Circuits or programmable logic devices.

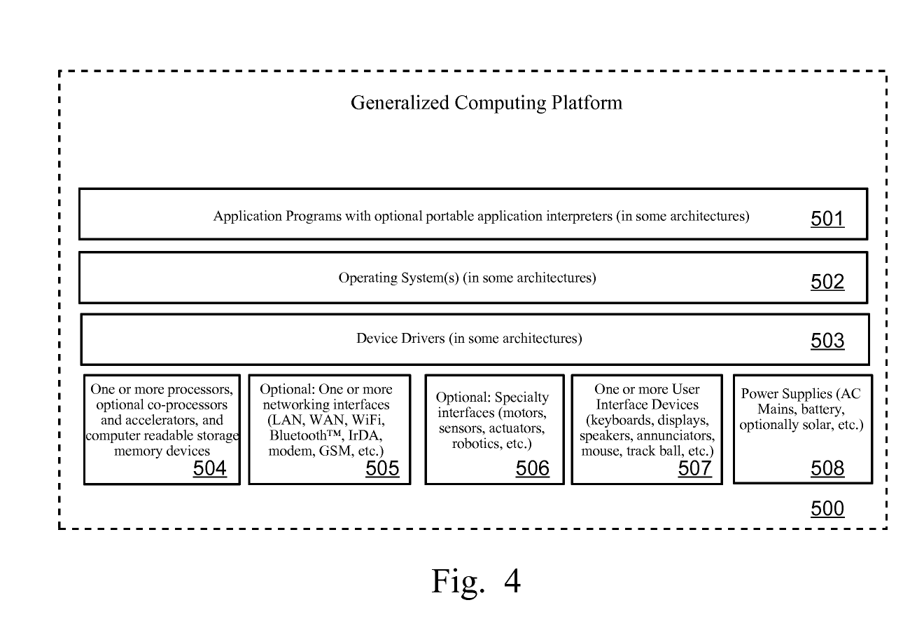

The present invention may be realized for many different processors used in many different computing platforms. FIG. 4 illustrates a generalized computing platform (500), such as common and well-known computing platforms such as “Personal Computers”, web servers such as an IBM iSeries™ server, and portable devices such as personal digital assistants and smart phones, running a popular operating systems (502) such as Microsoft™ Windows™ or IBM™ AIX™, Palm OS™, Microsoft Windows Mobile™, UNIX, LINUX, Google Android™, Apple iPhone iOS™, and others, may be employed to execute one or more application programs to accomplish the computerized methods described herein. Whereas these computing platforms and operating systems are well known an openly described in any number of textbooks, websites, and public “open” specifications and recommendations, diagrams and further details of these computing systems in general (without the customized logical processes of the present invention) are readily available to those ordinarily skilled in the art.

Many such computing platforms, but not all, allow for the addition of or installation of application programs (501) which provide specific logical functionality and which allow the computing platform to be specialized in certain manners to perform certain jobs, thus rendering the computing platform into a specialized machine. In some “closed” architectures, this functionality is provided by the manufacturer and may not be modifiable by the end-user.

The “hardware” portion of a computing platform typically includes one or more processors (504) accompanied by, sometimes, specialized co-processors or accelerators, such as graphics accelerators, and by suitable computer readable memory devices (RAM, ROM, disk drives, removable memory cards, etc.). Depending on the computing platform, one or more network interfaces (505) may be provided, as well as specialty interfaces for specific applications. If the computing platform is intended to interact with human users, it is provided with one or more user interface devices (507), such as display(s), keyboards, pointing devices, speakers, etc. And, each computing platform requires one or more power supplies (battery, AC mains, solar, etc.).

### CONCLUSION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof, unless specifically stated otherwise.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

It should also be recognized by those skilled in the art that certain embodiments utilizing a microprocessor executing a logical process may also be realized through customized electronic circuitry performing the same logical process(es).

It will be readily recognized by those skilled in the art that the foregoing example embodiments do not define the extent or scope of the present invention, but instead are provided as illustrations of how to make and use at least one embodiment of the invention. The following claims define the extent and scope of at least one invention disclosed herein.

What is claimed is:

1. A method for providing a restricted auction in a computing system comprising:
receiving by a social auction integration server at least one parameter regarding an item to be offered in an online auction by an offeror user;
using the parameter and an identifier of the offeror user, searching by the social auction integration server at least one social network server for identifies of users of the social network server that have a recorded affinity for the item or for similar items, wherein the identified users are also recorded as friends or associates of the offeror user;
preparing by the social auction integration server a list of the friend users and associate users;
configuring by the social auction integration server in an auction server a restricted auction wherein only the friend users and associate users are allowed to review and bid on the offered item; and
providing by the social auction integration server to the friend users and associate users through the social network server a digital means for accessing the restricted auction.

2. The method as set forth in claim 1 wherein the digital means for accessing the restricted auction comprises a private hyperlink.

3. The method as set forth in claim 1 wherein the digital means for accessing the restricted auction comprises a password.

4. The method as set forth in claim 1 wherein the digital means for accessing the restricted auction comprises a key value.

5. The method as set forth in claim 1 wherein the digital means for accessing the restricted auction comprises a cryptographic certificate file.

6. The method as set forth in claim 1 further comprising, prior to configuring the restricted auction, providing by the social auction integration server to the offeror user the list, and receiving a modified list from the offeror user, wherein the step of providing the digital means for accessing the restricted auction comprises providing the digital means only to users on the modified list.

7. The method as set for in claim 1 further comprising:
responsive to configuring the restricted auction, starting by the social auction integration server a timer; and
responsive to expiration of the timer, and responsive to the item being unsold, reconfiguring the restricted by the social auction integration server via the auction server to be unrestricted, thereby allowing bidders to view and bid on the item which are not on the friend user and associate user list.
